(19) United States
(12) Patent Application Publication
(10) Pub. No.: US 2026/0286071 A1
(43) Pub. Date: Sep. 24, 2026

(54) POLYMERIC MATERIALS COMPRISING DISULFIDE BRIDGES, ARTICLES, AND METHODS OF MAKING AND USING SAME

(71) Applicant: 3M INNOVATIVE PROPERTIES COMPANY, St. Paul, MN (US)

(72) Inventors: Adrian T. Jung, Kaarst (DE); Boris Ove Alexander Tasch, Düsseldorf (DE); Ahmad Shaaban, Koeln (DE); Annika C. Habicht, Korschenbroich (DE); Torsten Koppenhagen, Neuss (DE); Andreas Backes, Kaarst (DE); Michael Kempf, Neuss (DE); Sascha Sprott, Essen (DE)

(21) Appl. No.: 19/471,718

(22) PCT Filed: Apr. 10, 2024
(86) PCT No.: PCT/IB2024/053508

§ 371 Date: Oct. 2, 2025

Related U.S. Application Data
(60) Provisional application No. 63/503,728, filed on May 23, 2023.

(51) Int. Cl. C08J 3/24; C08J 9/232; C08J 9/36

(52) U.S. Cl. CPC C08J 3/246; C08J 3/247; C08J 9/232; C08J 9/36; C08J 2203/22; C08J 2363/00; C08J 2381/04

(57) ABSTRACT

Provided are compositions including a reaction product of a polymerizable mixture containing a multifunctional epoxy component; a polysulfide component including at least one disulfide bridge; and a base having a sufficiently high basicity to deprotonate an —SH group of the polysulfide component. The reaction product is in a form of a polymeric matrix. The composition can be attached to an object, for instance located between two objects. Additionally, methods of making articles including the composition, bonding two objects together, and aiding debonding of two objects, are provided.

### TECHNICAL FIELD

The present disclosure generally relates to polymeric bonding of one or more objects, and related methods.

### BACKGROUND

Various polymeric materials (e.g., adhesives) are known to be useful for bonding one substrate to another, e.g., a metal to a metal, a metal to a plastic, a plastic to a plastic, a glass to a glass. Further developments in bonding technologies to provide advantageous aspects to bonding solutions are desirable.

### SUMMARY

In a first aspect, a composition is provided. The composition comprises a reaction product of a polymerizable mixture comprising a multifunctional epoxy component; a polysulfide component comprising at least one disulfide bridge; and a base having a sufficiently high basicity to deprotonate an —SH group of the polysulfide component. The reaction product is in a form of a polymeric matrix.

In a second aspect, an article is provided. The article comprises an object having an exterior surface and a composition attached to at least a portion of the exterior surface of the object. The composition comprises a reaction product of a polymerizable mixture comprising a multifunctional epoxy component; a polysulfide component comprising at least one disulfide bridge; and a base having a sufficiently high basicity to deprotonate an —SH group of the polysulfide component. The reaction product is in a form of a polymeric matrix.

In a third aspect, a method of making an article is provided. The method comprises applying a polymerizable mixture to at least a portion of an exterior surface of an object and polymerizing the mixture to form an at least partially cured composition. The polymerizable mixture comprises a multifunctional epoxy component; a polysulfide component comprising at least one disulfide bridge; and a base having a sufficiently high basicity to deprotonate an —SH group of the polysulfide component. The reaction product is in a form of a polymeric matrix.

In a fourth aspect, another method of making an article is provided. The method comprises obtaining an at least partially cured composition that is a reaction product of a polymerizable mixture. The polymerizable mixture comprises a multifunctional epoxy component; a polysulfide component comprising at least one disulfide bridge; and a base having a sufficiently high basicity to deprotonate an —SH group of the polysulfide component. The reaction product is in a form of a polymeric matrix. The method further comprises directly contacting the at least partially cured composition with at least a portion of an exterior surface of an object and maintaining the direct contact between the at least partially cured composition and the exterior surface of the object for a time sufficient for the rearrangement of disulfide bridges to adhere the at least partially cured composition to the exterior surface of the object.

In a fifth aspect, a method of adhering two objects together is provided. The method comprises obtaining a first article according to the second aspect, in which the object is a first object and the composition is a first composition; and obtaining a second article according to the second aspect, in which the object is a second object and the composition is a second composition. The method further comprises directly contacting the first composition with the second composition; and maintaining the direct contact between the first composition and the second composition for a time sufficient for the formation of disulfide bridges between the first composition and the second composition, thereby adhering the first object and the second object together.

In a sixth aspect, a method of aiding debonding of a first object from a second object is provided. The method comprises obtaining an article comprising a first object having an exterior surface; a composition attached to at least a portion of the exterior surface of the first object; and a second object adhered to the composition opposite the first object. The composition comprises a foaming agent and a reaction product of a polymerizable mixture comprising a multifunctional epoxy component; a polysulfide component comprising at least one disulfide bridge; and a base having a sufficiently high basicity to deprotonate an —SH group of the polysulfide component. The reaction product is in a form of a polymeric matrix. The method also comprises activating the foaming agent to form a foam composition, thereby decreasing a cohesion within the composition.

It has been discovered that the self-repair feature of disulfide bridges can be leveraged to provide bonding solutions that in at least some embodiments exhibit at least one characteristic of: greater sustainability, greater repairability, greater flexibility, or lower environmental impact, than prior adhesives. Additional features and advantages of the present disclosure will be further understood upon consideration of the detailed description as well as the appended claims.

### BRIEF DESCRIPTION OF THE DRAWINGS

FIG. 1 is a schematic cross-sectional view of an exemplary article 100, according to various exemplary embodiments disclosed herein.

FIG. 2 is a schematic cross-sectional view of an exemplary article 200, according to various exemplary embodiments disclosed herein.

FIG. 3 is a schematic representation is provided of a self-joining mechanism of exemplary compositions according to various embodiments disclosed herein.

While the above-identified figures set forth several embodiments of the disclosure other embodiments are also contemplated, as noted in the description. The figures are not necessarily drawn to scale. In all cases, this disclosure presents aspects of the invention by way of representation and not limitation.

### DETAILED DESCRIPTION

### Glossary

The term “alkyl” refers to a monovalent group that is a radical of an alkane, which is a saturated hydrocarbon. The alkyl can be linear, branched, cyclic, or combinations thereof and typically has 1 to 20 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, and ethylhexyl.

The term “alkylene” refers to a divalent group that is a radical of an alkane. The alkylene can be straight-chained, branched, cyclic, or combinations thereof. The alkylene typically has 1 to 20 carbon atoms. The radical centers of the alkylene can be on the same carbon atom (i.e., an alkylidene) or on different carbon atoms.

The term “heteroalkylene” refers to an alkylene having one or more —CH₂— groups replaced with a thio, oxy, or —NR^{b}— where R^{b} is hydrogen or alkyl. The heteroalkylene can be linear, branched, cyclic, or combinations thereof. Exemplary heteroalkylene include alkylene oxides or poly(alkylene oxides). That is, the heteroalkylenes include at least one group of formula —(R—O)— where R is an alkylene.

The term “(meth)acrylate” or “(meth)acrylic acid” is used herein to denote the corresponding acrylate and methacrylate. Thus, for instance, the term “(meth)acrylic acid” covers both methacrylic acid and acrylic acid, and the term “(meth)acrylate” covers both acrylates and methacrylates. The (meth)acrylate or the (meth)acrylic acid may consist only of the methacrylate or methacrylic acid, respectively, or may consist only of the acrylate or the acrylic acid, respectively, yet may also relate to a mixture of the respective acrylate and methacrylate (or acrylic acid and methacrylic acid).

The term “polysulfide” refers to a material containing two or more atoms of sulfur per molecule.

The term “nonplanar” with respect to a surface of an object refers to the surface having a three-dimensional quality, as opposed to just a two-dimensional quality of a planar surface.

As used herein, “adjacent” encompasses both in direct contact (e.g., directly adjacent) and having one or more intermediate layers present between the adjacent materials.

As used herein, “attached” encompasses both directly attached and having being attached via one or more intermediate layers (including surface modification) present between the attached materials.

The term “zero gap contact” refers to direct physical contact between two materials.

The term “crosslinked” (co) polymer refers to a (co) polymer whose (co) polymer chains are joined together by covalent chemical bonds, usually via crosslinking molecules or groups, to form a network (co) polymer. A crosslinked (co) polymer is generally characterized by insolubility but may be swellable in the presence of an appropriate solvent.

The term “cure” refers to a process that causes a chemical change, (e.g., a reaction that creates a covalent bond to solidify a multilayer film layer or increase its viscosity.

The term “partially cured” refers to part of a curable material being cured to such a degree that it will not substantially flow.

The term “cured (co) polymer” includes both crosslinked and uncrosslinked (co) polymers.

The phrase “comprises at least one of” followed by a list refers to comprising any one of the items in the list and any combination of two or more items in the list. The phrase “at least one of” followed by a list refers to any one of the items in the list or any combination of two or more items in the list.

As used herein, the term “and/or” is used to indicate one or both stated cases may occur, for example A and/or B includes, (A and B) and (A or B).

As used herein, the term “room temperature” refers to a temperature in the range of 20° C. to 25° C.

The term “substantially” with reference to a property or characteristic means that the property or characteristic is exhibited to a greater extent than the opposite of that property or characteristic is exhibited.

### Compositions

In a first aspect, the present disclosure provides a composition comprising a reaction product of a polymerizable mixture comprising:
a multifunctional epoxy component;
a polysulfide component comprising at least one disulfide bridge; and
a base having a sufficiently high basicity to deprotonate an —SH group of the polysulfide component,
wherein the reaction product is in a form of a polymeric matrix.

The reaction product is a product formed from polymerization of the polymerizable mixture that contains at least the multifunctional epoxy component, the polysulfide component, and the base. By “polymeric matrix” is meant a three-dimensionally continuous surrounding medium or structure that is polymeric. This is in contrast, for instance, to a cement or a mineral, each of which has a three-dimensionally continuous inorganic matrix.

A general representation of one possible reaction scheme to form an exemplary reaction product is provided below, including the use of thiol-terminated polysulfide oligomers as the polysulfide component, bisphenol F/A epoxy resins as the multifunctional epoxy component, and a tertiary amine as the base. One suitable use of the reaction product is as a sealant for an object.

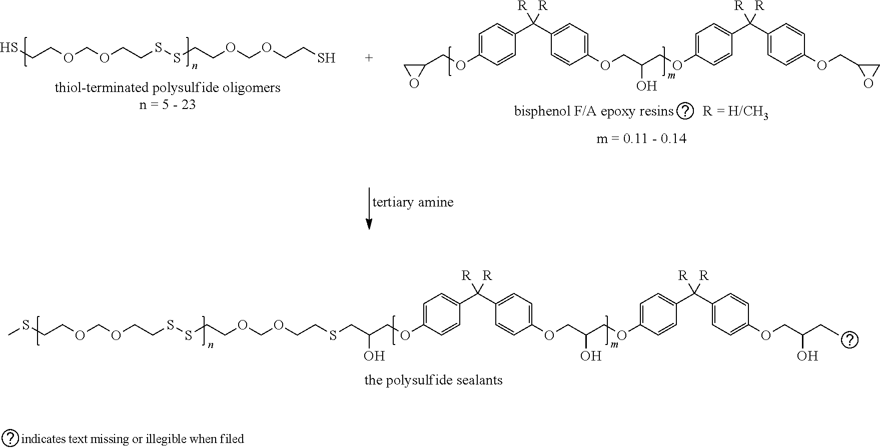

The composition may take the form of a film-like self-supporting composition or a multi-dimensional object having a dimensional stability, which makes it possible for it to be pre-applied on a selected substrate, in particular a liner, until further processing. Advantageously, the composition may be appropriately shaped to fulfil the requirements of any specific applications.

In some embodiments, the composition exhibits favorable viscosity properties, allowing high loadings of functional fillers. This enables characteristics such as light weighting, vibration dampening, flame retardancy, expansion, thermal conductivity, and/or electrical conductivity.

In some embodiments, the composition further comprises a filler distributed in the polymeric matrix in an amount of 10 volume percent (vol. %) or greater, based on the total volume of the composition, 15 vol. %, 20 vol. %, 25 vol. %, 30 vol. %, 35 vol. %, 40 vol. %, 45 vol. %, or 50 vol. %; and 80 vol. % or less, 75 vol. %, 70 vol. %, 65 vol. %. 60 vol. %, 55 vol. %, 50 vol. %, 45 vol. %, or 40 vol. % or less, based on the total volume of the composition. In some embodiments, a filler is distributed in the polymeric matrix in an amount of 10 weight percent (wt. %) or greater, based on the total weight of the composition, 15 wt. %, 20 wt. %, 25 wt. %, 30 wt. %, 35 wt. %, 40 wt. %, 45 wt. %, or 50 wt. %; and 80 wt. % or less, 75 wt. %, 70 wt. %, 65 wt. %. 60 wt. %, 55 wt. %, 50 wt. %, 45 wt. %, or 40 wt. % or less, based on the total weight of the composition.

In certain embodiments, the filler is selected from the group consisting of lightweight particles, foaming agents, expandable minerals, expanded microspheres, flame retardants, thermally conductive particles, thermally insulating particles, electrically conductive particles, electrically insulative particles, and combinations thereof.

Suitable lightweight particles are typically hollow microspheres, amorphous materials or aerogels. The specific gravity of the microspheres ranges from about 0.1 to about 0.7 and are exemplified by polystyrene foam, microspheres of polyacrylates and polyolefins, and silica microspheres having particle sizes ranging from 5 to 100 microns and a specific gravity of 0.25 sold under the trade name “ECCOSPHERES” by W.R. Grace & Co. Other examples include alumina/silica microspheres having particle sizes in the range of 5 to 300 microns and a specific gravity of 0.7 sold under the trade name “FILLITE” by Pluess-Stauffer International, aluminum silicate microspheres having a specific gravity of from about 0.45 to about 0.7 sold under the trade name “Z-LIGHT”, and calcium carbonate-coated polyvinylidene copolymer microspheres having a specific gravity of 0.13 which are sold under the trade name “DUALITE 6001AE” by Pierce & Stevens Corp. Amorphous lightweight particles typically have a specific gravity ranging from about 1.0 to about 2.2, while an aerogel has a specific gravity of from 0.05 to 0.07. The amorphous lightweight particles are exemplified by calcium silicates, fumed silica, precipitated silica, and polyethylene. Examples include calcium silicate having a specific gravity of from 2.1 to 2.2 and a particle size of from 3 to 4 microns sold under the trade name “HUBERSORB HS-600” by J. M. Huber Corp., and fumed silica having a specific gravity of 1.7 to 1.8 with a particle size less than 1 micron sold under the trade name “CAB-O-SIL TS-720” by Cabot Corp. Other examples include precipitated silica having a specific gravity of from 2 to 2.1 sold under the trade name “HI-SIL T-7000” by PPG Industries, and polyethylene having a specific gravity of from 1 to 1.1 and a particle size of from 10 to 20 microns sold under the trade name “SHAMROCK S-395” by Shamrock Technologies Inc.

Suitable foaming agents can include an expandable microsphere as described herein. The foaming agent can also include an exothermic chemical blowing agent, an endothermic chemical blowing agent, a physical blowing agent, or mixtures thereof. Examples of suitable exothermic chemical blowing agents include an azo compound, a diazo compound, a sulfonyl hydrazide, a sulfonyl semicarbazide, a tetrazole, a nitroso compound, an acyl sulfonyl hydrazide, a hydrazine, a thiatriazole, an azides, a sulfonyl azide, an oxalate, a thiatrizene dioxide, isotoic anhydride, ammonium nitrite, or mixtures thereof. Examples of suitable endothermic chemical blowing agents include an inorganic carbonate, a bicarbonate, a nitrate, a borohydride, citric acid, polycarbonic acid, or mixtures thereof. The physical blowing agent can include a compressed gas, a liquid, a solid, or mixtures thereof. Specific materials that can be suitable physical blowing agents include carbon dioxide, nitrogen, argon, water, butane, 2,2-dimethylpropane, pentane, hexane, heptane, 1-pentene, 1-hexene, 1-heptene, benzene, toluene, a fluorinated hydrocarbon, methanol, ethanol, isopropanol, ethyl ether, isopropyl ketone, or mixtures thereof.

Suitable expandable minerals comprise at least one of sodium silicate, intercalated graphite, aluminum hydroxide, magnesium hydroxide, ammonium polyphosphate, clay, or vermiculite. Useful expandable minerals also include unexpanded vermiculite ore, treated unexpanded vermiculite ore, partially dehydrated vermiculite ore, expandable graphite (e.g., expandable graphite flakes available, for example, under the trade designation “GRAFOIL GRADE 338-50” from UCAR Carbon Co., Inc. (Cleveland, OH), mixtures of expandable graphite with treated and/or untreated unexpanded vermiculite ore, processed expandable sodium silicate (e.g., an insoluble sodium silicate available, for example, under the trade designation “EXPANTROL” from 3M Company (St. Paul, MN), and mixtures thereof. Treated unexpanded vermiculite flakes or ore include unexpanded vermiculite treated by processes such as by being ion exchanged with ion exchange salts (e.g., ammonium dihydrogen phosphate, ammonium nitrate, ammonium chloride, potassium chloride, and other suitable compounds as is known in the art).

Expanded microspheres are obtained by exposing expandable microspheres to heat. A wide range of expandable microspheres are suitable. Suitable expandable microspheres are ones with low density, high elasticity, and low moisture absorption such as those commercially available from Nouryon under the trade name “EXPANCEL” such as “EXPANCEL 920DU20”. In some embodiments, the expandable microspheres have a maximum expansion ratio of 6.4

Suitable flame retardant particles include for example ammonium polyphosphate, alumina trihydrate, magnesium hydroxide, huntite, and hydromagnesite. Ammonium polyphosphate is an inorganic salt of polyphosphoric acid and ammonia and may be either a linear or branched polymer. Its chemical formula is [NH₄PO₃]ₙ(OH)₂, where each monomer consists of an orthophosphate radical of a phosphorus atom with three oxygens and one negative charge neutralized by an ammonium cation leaving two bonds free to polymerize. In the branched cases some monomers are missing the ammonium anion and instead link to other monomers. Organophosphates other than ammonium polyphosphate can also be used.

Suitable thermally conductive particles optionally include a mixture of two or more particle types selected from carbon black, graphite, graphene, aluminum, copper, silver, graphite, diamond, SiC, Si₃N₄, AlN, BeO, MgO, Al₂O₃, aluminum hydroxide, aluminum oxyhydroxide, hexagonal boron nitride (h-BN), cubic boron nitride (c-BN), ZnO, natural aluminosilicate, or synthetic aluminosilicate, or a combination thereof.

Suitable thermally insulating particles include ceramics (including glasses, crystalline ceramics, and glass-ceramics) and polymers. Exemplary thermally insulating particles comprise at least one of a ceramic (e.g., glass bubbles), vermiculite, perlite, celite, an aerogel, or a polymer. In some embodiments, the thermally insulating particles are in the form of hollow particles, bubbles, or porous material, to entrap more air to provide better insulation.

Suitable electrically conductive particles include carbon particles such as carbon black, graphite or graphene, or a combination thereof; and metal particles comprising at least one metal selected from aluminum, copper, nickel, platinum, silver and gold, or a combination thereof.

Suitable electrically insulative particles include boron nitride particles, talc particles, and amorphous silica coated particles.

As can be seen from the above description, some fillers are included in more than one category of types of particles.

In some embodiments, the composition has a form of a foamed polymeric matrix. Foams are porous materials that are composed of gas filled networks or chambers segmented by a solid matrix. The properties of foamed materials are governed by the composition of the matrix material and the morphology of its cellular structure. The polymeric matrix is provided by the reaction product of (at least) the multifunctional epoxy component, polysulfide component, and base, and the foam is provided by the inclusion of at least one foaming agent or expanded microspheres, as known to those of ordinary skill in the art of foams.

### Polymerizable Mixtures

Polymerizable mixtures of the present disclosure may be prepared by methods known to those of ordinary skill in the relevant arts. Each of the components of the polymerizable mixture of a composition is described in detail below.

### Epoxy Component

The polymerizable mixture contains a multifunctional epoxy component, such as an epoxy resin.

Epoxy resins are well known to those skilled in the art. For instance, some suitable epoxy resins for use herein and their methods of manufacturing are amply described for example in EP-A1-2 700 683 (Elgimiabi et al.) and in WO 2017/197087 (Aizawa).

The multifunctional epoxy component may optionally include an epoxy resin comprising one or more epoxy compounds that can be monomeric or polymeric, and aliphatic, cycloaliphatic, heterocyclic, aromatic, hydrogenated, and/or a mixture thereof. Preferred epoxy compounds contain more than 1.5 epoxy groups per molecule and more preferably at least 2 epoxide groups per molecule.

The multifunctional epoxy component can include linear polymeric epoxides having terminal epoxy groups (e.g., a diglycidyl ether of a polyoxyalkylene glycol), polymeric epoxides having skeletal epoxy groups (e.g., polybutadiene poly epoxy), polymeric epoxides having pendant epoxy groups (e.g., a glycidyl methacrylate polymer or copolymer), or a mixture thereof.

Useful multifunctional epoxy compounds also include aromatic glycidyl ethers, e.g., such as those prepared by reacting a polyhydric phenol with an excess of epichlorohydrin, cycloaliphatic glycidyl ethers, hydrogenated glycidyl ethers, and mixtures thereof. Such polyhydric phenols may include resorcinol, catechol, hydroquinone, and the polynuclear phenols such as p,p′-dihydroxydibenzyl, p,p′-dihydroxydiphenyl, p,p′-dihydroxyphenyl sulfone, p,p′-dihydroxybenzophenone, 2,2′-dihydroxy-1,1-dinaphthylmethane, and the 2,2′-, 2,3′-, 2,4′-, 3,3′-, 3,4′-, and 4,4′-isomers of dihydroxydiphenylmethane, dihydroxydiphenyldimethyl-methane, dihydroxydiphenylethylmethylmethane, dihydroxydiphenylmethylpropylmethane, dihydroxy-diphenylethylphenylmethane, dihydroxydiphenylpropylphenylmethane, dihydroxydiphenylbutylphenyl-methane, dihydroxydiphenyltolylethane, dihydroxydiphenyltolylmethylmethane, dihydroxydiphenyl-dicyclohexylmethane, and dihydroxydiphenylcyclohexane.

Similarly, useful multifunctional epoxy compounds also include a polyglycidyl ether of a polyhydric phenol. Example polyglycidyl ethers of a polyhydric phenol include a polyglycidyl ether of bisphenol A, bisphenol F, bisphenol AD, catechol, or resorcinol.

Useful multifunctional epoxy compounds also include glycidyl ether esters and polyglycidyl esters. A glycidyl ether ester may be obtained by reacting a hydroxycarboxylic acid with epichlorohydrin. A polyglycidyl ether may be obtained by reacting a polycarboxylic acid with epichlorohydrin. Such polycarboxylic acids may include a dimer acid (e.g., RADIACID 0950 from Oleon, Simpsonville, SC), and a trimer acid (e.g., RADIACID 0983 from Oleon). Suitable glycidyl esters include a glycidyl ester of neodecanoic acid (e.g., ERISYS GS-110 from CVC Specialty Chemicals) and a glycidyl ester of a dimer acid (e.g., DRISYS GS-120 from CVC Specialty Chemicals).

Exemplary multifunctional epoxy compounds also include glycidyl ethers of bisphenol A, bisphenol F, and novolac resins as well as glycidyl ethers of aliphatic or cycloaliphatic diols. Examples of commercially available glycidyl ethers include diglycidyl ethers of bisphenol A such as those available as EPON 828, EPON 1001, EPON 1310, and EPON 1510 from Hexion Specialty Chemicals GmbH, Rosbach, Germany; those available under the trade name D.E.R. (e.g., D.E.R. 331, 332, and 334) from Dow Chemical Co., Midland, Michigan; those available under the trade name EPICLON from Dainippon Ink and Chemicals, Inc. (e.g., EPICLON 840 and 850) and those available under the trade name YL-980 from Japan Epoxy Resins Co., Ltd.); diglycidyl ethers of bisphenol F (e.g., those available under the trade name EPICLON from Dainippon Ink and Chemicals, Inc. (e.g., EPICLON 830)); glycidyl ethers of novolac resins (e.g., novolac epoxy resins, such as those available under the trade name D.E.N. from Dow Chemical Co. (e.g., D.E.N. 425, 431, and 438)); and flame retardant epoxy resins (e.g., D.E.R. 580, a brominated bisphenol type epoxy resin available from Dow Chemical Co.). In some embodiments, aromatic glycidyl ethers, such as those prepared by reacting a dihydric phenol with an excess of epichlorohydrin, may be preferred. In some embodiments, nitrile rubber modified epoxies may be used (e.g., KELPOXY 1341 available from CVC Chemical).

Exemplary multifunctional epoxy compounds include, for example, aliphatic (including cycloaliphatic) and aromatic epoxy compounds. The epoxy compound(s) may be monomeric, oligomeric, or polymeric epoxides, or a combination thereof. The epoxy component may be a pure compound or a mixture comprising at least two epoxy compounds. The multifunctional epoxy component typically has, on average, at least 1.5 epoxy (i.e., oxiranyl) group per molecule, preferably at least about 2 epoxy groups per molecule. In some cases, 3 (e.g., trifunctional epoxy), 4, 5, or even 6 epoxy groups may be present, on average. Polymeric epoxides include linear polymers having terminal epoxy groups (e.g., a diglycidyl ether of a polyoxyalkylene glycol), polymers having skeletal oxirane units (e.g., polybutadiene polyepoxide), and polymers having pendent epoxy groups (e.g., a glycidyl methacrylate polymer or copolymer). Other useful multifunctional epoxy components are polyhydric phenolic formaldehyde condensation products as well as polyglycidyl ethers that contain as reactive groups only epoxy groups or hydroxy groups. In certain embodiments, the epoxy component comprises more than one glycidyl ether group. The “average” number of epoxy groups per molecule can be determined by dividing the total number of epoxy groups in the epoxy-containing material by the total number of epoxy-containing molecules present.

Exemplary suitable multifunctional epoxy components include for instance, 3,4-epoxycyclohexylmethyl-3,4-epoxycyclohexenecarboxylate, 3,4-epoxy-6-methylcyclohexylmethyl-3,4-epoxy-6-methylcyclohexene carboxylate, bis(3,4-epoxy-6-methylcyclohexylmethyl) adipate, bis(2,3-epoxycyclopentyl) ether, dipentene dioxide, silicone resin containing epoxy functionality, flame retardant epoxy resins (e.g., DER-580, a brominated bisphenol type epoxy resin available from Dow Chemical Co.), 1,4-butanediol diglycidyl ether of phenol-formaldehyde novolac (e.g., DEN-431 and DEN-438 from Dow Chemical Co.), and resorcinol diglycidyl ether (e.g., Kopoxite from Koppers Company, Inc.), bis(3,4-epoxycyclohexyl) adipate, 2-(3,4-epoxycyclohexyl-5,5-spiro-3,4-epoxy)cyclohexene metadioxane, vinylcyclohexene monoxide 1,2-epoxyhexadecane, alkyl glycidyl ethers such as (e.g., HELOXY Modifier 7 from Momentive Specialty Chemicals, Inc., Waterford, NY), alkyl C12-C14 glycidyl ether (e.g., HELOXY Modifier 8 from Momentive Specialty Chemicals, Inc.), butyl glycidyl ether (e.g., HELOXY Modifier 61 from Momentive Specialty Chemicals, Inc.), cresyl glycidyl ether (e.g., HELOXY Modifier 62 from Momentive Specialty Chemicals, Inc.), p-tert-butylphenyl glycidyl ether (e.g., HELOXY Modifier 65 from Momentive Specialty Chemicals, Inc.), polyfunctional glycidyl ethers such as diglycidyl ether of 1,4-butanediol (e.g., HELOXY Modifier 67 from Momentive Specialty Chemicals, Inc.), diglycidyl ether of neopentyl glycol (e.g., HELOXY Modifier 68 from Momentive Specialty Chemicals, Inc.), diglycidyl ether of cyclohexanedimethanol (e.g., HELOXY Modifier 107 from Shell Chemical Co.), trimethylolethane triglycidyl ether (e.g., HELOXY Modifier 44 from Momentive Specialty Chemicals, Inc.), trimethylolpropane triglycidyl ether (e.g., HELOXY Modifier 48 from Momentive Specialty Chemicals, Inc.), polyglycidyl ether of an aliphatic polyol (e.g., HELOXY Modifier 84 from Momentive Specialty Chemicals, Inc.), polyglycol diepoxide (e.g., HELOXY Modifier 32 from Momentive Specialty Chemicals, Inc.), bisphenol F epoxides, 9,9-bis[4-(2, 3-epoxypropoxy)phenyl] fluorenone (e.g., EPON 1079 from Momentive Specialty Chemicals, Inc.).

In certain embodiments, the epoxy component comprises an epoxidised (poly) olefinic resin, an epoxidised phenolic novolac resin, an epoxidised cresol novolac resin, a cycloaliphatic epoxy resin, or a combination thereof. Commercially available epoxy resins include for instance, epoxidised linseed oil (e.g., VIKOFLEX 7190 from Arkema Inc., King of Prussia, Pennsylvania), epoxy phenol novolac resin (e.g., EPALLOY 8250 from CVC Specialty Chemicals, Moorestown, New Jersey), multifunctional ephichlorohydrin/cresol novolac epoxy resin (e.g., EPON 164 from Hexion Specialty Chemicals GmbH, Rosbach, Germany), and cycloaliphatic epoxy resin (e.g., CELLOXIDE 2021 from Daicel Chemical Industries, Ltd., Tokyo, Japan).

Exemplary epoxy resins for use herein may be advantageously selected from the group consisting of phenolic epoxy resins, bisphenol epoxy resins, hydrogenated epoxy resins, aliphatic epoxy resins, halogenated bisphenol epoxy resins, novolac epoxy resins, and any mixtures thereof. The epoxy resin for use in the present disclosure often comprises glycidyl groups.

In certain embodiments, the multifunctional epoxy component comprises at least one of an aromatic epoxy component, a fully or partially hydrogenated epoxy component, or combinations thereof. The multifunctional epoxy component comprises at least one of a difunctional epoxy component, a trifunctional epoxy component, or a tetrafunctional epoxy component. In some cases, the multifunctional epoxy component comprises at least one of a novolac-based epoxy component, a bisphenol A-based epoxy component, or a bisphenol F-based epoxy component.

According to a typical aspect, an amount of the multifunctional epoxy component in the polymerizable mixture is 2 wt. % or greater, 5 wt. %, 7 wt. %, 10 wt. %, 15 wt. %, 20 wt. %, 25 wt. %, 30 wt. %, 35 wt. %, 40 wt. %, 45 wt. %, 50 wt. %, 55 wt. %, or 60 wt. %, or greater, wherein the weight percentages are based on the total weight of the polymerizable components of the polymerizable mixture; and 90 wt. % or less, 85 wt. %, 80 wt. %, 75 wt. %, 70 wt. %, 65 wt. %, 60 wt. %, 55 wt. %, 50 wt. %, 45 wt. %, 40 wt. %, 35 wt. %, or 30 wt. % or less, based on the total weight of the polymerizable components of the polymerizable mixture.

### Polysulfide Components

Polysulfide components for the polymerizable mixture of the present disclosure comprise at least one polysulfide that includes disulfide linkages (i.e., —S—S—) in its backbone structure.

Polysulfides are typically prepared by the condensation of sodium polysulfide with bis-(2-chloroethyl) formal, which provides linear polysulfides having two terminal mercaptan groups. Branched polysulfides having three or more mercaptan groups can be prepared using trichloropropane in the reaction mixture. Examples of useful polysulfides are described, for example, in U.S. Pat. No. 2,466,963 (Patrick et al); U.S. Pat. No. 2,789,958 (Fettes et al); U.S. Pat. No. 4,165,425 (Bertozzi); and 5,610,243 (Vietti et al.).

In some cases, the polysulfide component comprises at least three, at least four, or at least five disulfide bridges. Optionally, the polysulfide component comprises thiol end groups.

Polysulfides are commercially available under the trademarks “THIOKOL” and “LP” from Toray Fine Chemicals Co., Ltd., Urayasu, Japan and are exemplified by grades “LP-2”, “LP-2C” (branched), “LP-3”, “LP-33”, “LP-55”, “LP-0010-BL”, “LP-32M”, “LP12M” and “LP-541”, and under the trade designations “THIOPLAST G4” and “THIOPLAST G44” from Nouryon, Amsterdam, The Netherlands.

In some embodiments, the polysulfides can be represented by the following formula:

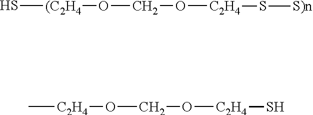

Polysulfides can have a variety of useful molecular weights. In some embodiments, the polysulfides have number average molecular weights in a range from 500 grams per mole to 20,000 grams per mole, 1,000 grams per mole to 10,000 grams per mole, or 2,000 grams per mole to 5,000 grams per mole.

According to a typical aspect, an amount of the polysulfide component in the polymerizable mixture is 2 wt. % or greater, 5 wt. %, 7 wt. %, 10 wt. %, 15 wt. %, 20 wt. %, 25 wt. %, 30 wt. %, 35 wt. %, 40 wt. %, 45 wt. %, 50 wt. %, 55 wt. %, or 60 wt. %, or greater, wherein the weight percentages are based on the total weight of the polymerizable components of the polymerizable mixture; and 90 wt. % or less, 85 wt. %, 80 wt. %, 75 wt. %, 70 wt. %, 65 wt. %, 60 wt. %, 55 wt. %, 50 wt. %, 45 wt. %, 40 wt. %, 35 wt. %, or 30 wt. % or less, based on the total weight of the polymerizable components of the polymerizable mixture.

### Bases

The polymerizable mixture comprises a base having a sufficiently high basicity to deprotonate an —SH group of the polysulfide component. Exemplary suitable bases that will deprotonate a thiol group of the polysulfide component include at least one of a primary amine, a secondary amine, a tertiary amine, a cyclic amine, an aromatic amine, a monofunctional amine, a multifunctional amine, an epoxy-amine adduct, an amide, or any combination thereof. In some cases, the base comprises at least one of a primary amine, a secondary amine, a tertiary amine, or a multifunctional amine. In certain embodiments, the base comprises a multifunctional amine, such as tris-(dimethylaminomethyl) phenol, which is commercially available under the trade designation “ANCAMINE K54” from Evonik Corporation (Trexlertown, PA).

Examples of suitable bases include for instance and without limitation, ethylenediamine (EDA) and diethylenetriamine (DETA) as primary amines; DETA, triethylenetetramine (TETA), tetraethylene, and pentamine (TEPA) as secondary amines; tris-(dimethylaminomethyl) phenol as a tertiary amine; a aminoethylpiperazine and isophoronediamine as cyclic amines; 4′,4-methylenedianiline (MDA) as an aromatic amine; aniline as a monofunctional amine; TETA and TEPA as multifunctional amines; a formulated aliphatic polyamine adduct commercially available under the trade designation “ANCAMINE 3456” from Evonik Corporation as an epoxy-amine adduct. It is noted that epoxy-amine adducts are typically prepared from an epoxy and either a primary amine or a secondary amine, and the actual structure is not usually known. Additionally, it is clear that certain bases fit within more than one of the above categories.

### Optional Components

The polymerizable mixture according to the present disclosure optionally further comprises additional components, such as conventional additives. Additives may include, for example, colorant, a plasticizer, a catalyst, a diluent, and combinations thereof.

### Articles

In a second aspect, an article is provided. The article comprises an object having an exterior surface and a composition attached to at least a portion of the exterior surface of the object, the composition comprising a reaction product of a polymerizable mixture comprising:
a multifunctional epoxy component;
a polysulfide component comprising at least one disulfide bridge; and
a base having a sufficiently high basicity to deprotonate an —SH group of the polysulfide component,
   wherein the reaction product is in a form of a polymeric matrix.

The polymerizable mixture is as described in detail above with respect to the first aspect, including any of the various embodiments described therein. The object is not particularly limited; any item that would benefit from a coating/layer of the reaction product thereon is suitable (e.g., a substrate).

Referring to FIG. 1, in some embodiments of the article 100, a suitable object comprises a substrate 10 having a major surface 11 to which the composition 12 is attached. For simplicity, the article 100 depicted in FIG. 1 includes a planar substrate 10 and planar composition 12 disposed on the exterior major surface 11. However, it is expressly contemplated that the object could comprise a nonplanar exterior surface, and/or that the composition is on a minor area of the surface.

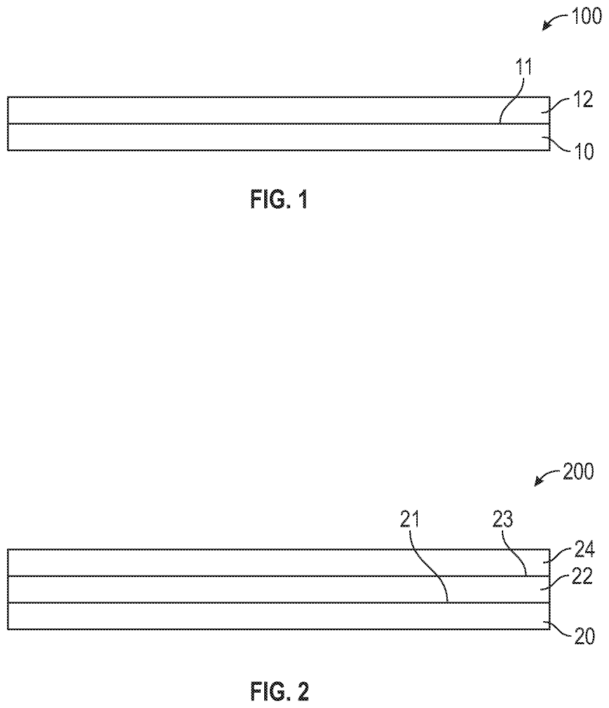

Referring to FIG. 2, in some embodiments of an article 200, an object 20 is a first object and the article 200 further comprises a second object 24 adhered to a composition 22 opposite the first object 20. For example, in the article depicted in FIG. 2, optionally the composition 22 is laminated between the first object 20 and the second object 24. Stated another way, in some cases a second object 24 is attached to a major surface 23 of the composition 22, and the composition 22 is attached to a major surface 21 of the first object 20. As indicated above, it is also expressly contemplated that the object (the first object and/or the second object) could comprise a nonplanar exterior surface, and/or that the composition is on a minor area of the surface of either or both objects.

The first and second objects are not particularly limited; any two parts that need to be adhered together would be suitable. For example, the first object could be a battery cell and the second object could be a different portion of a battery module assembly to which the battery cell is affixed. The object may comprise a material including plastic, glass, ceramic, metal, or any combination thereof. In some cases, an object may be a substrate and/or part comprising a metal selected from the group consisting of aluminum, steel, iron, and any mixtures, combinations or alloys thereof.

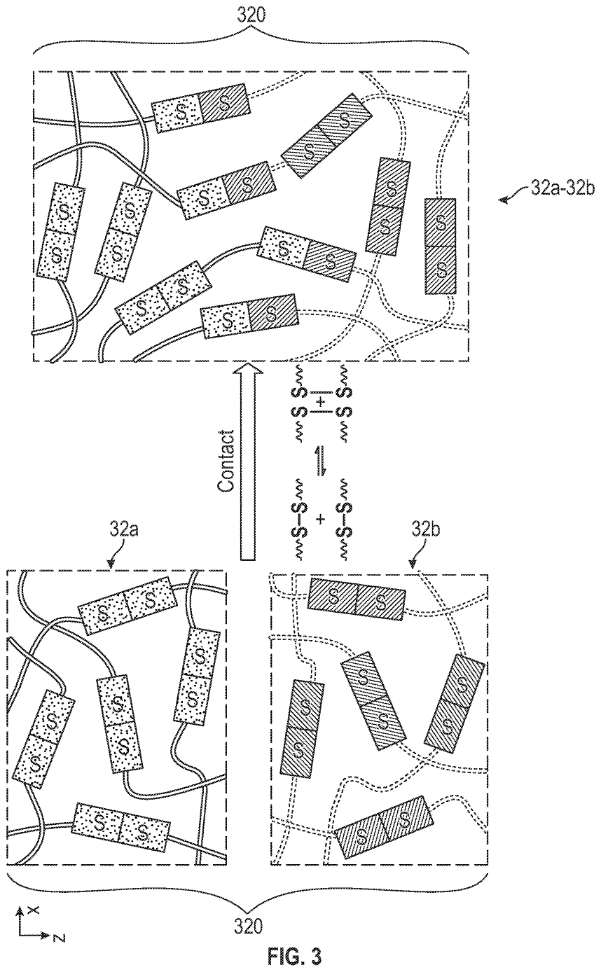

Advantageously, the disulfide bridges in the reaction product undergo (e.g., constant) opening and closing reactions, which allow for exchange reactions in between two different disulfide bridges. Referring to FIG. 3, a schematic representation is provided of a self-joining mechanism in which disulfide bridges from one polymer chain open and close with sulfur atoms of a different polymer chain. This creates a covalent bond between the two polymer chains. These exchange reactions also enable the reaction product to flow or spread out (e.g., “wet out”) on the surface of the object over time, providing favorable adhesion of the reaction product to the object. Also advantageously, the composition typically exhibits a non-tacky surface, which means that a (e.g., release) liner is not needed to protect the composition before use as is usually needed for a tacky adhesive material. An additional benefit is that the composition does not need to be exposed to radiation to initiate bonding, which enables its use in difficult to reach areas and/or with objects that are not sufficiently transparent to allow radiation to pass through the material. The self-joining mechanism further enables recycling of the composition as these intermolecular exchanges will generate bridging bonds between two parts of a composition that had been torn apart until rupture.

More particularly, in FIG. 3, a composition 320 is shown that initially contained a polymer chain 32a and a separate polymer chain 32b. Upon direct contact of the two polymer chains 32a and 32b together over time (and optionally with added heat), some of the disulfide bonds S—S within each of the polymer chain 32a and the polymer chain 32b opened and then closed with one sulfur atom from the polymer chain 32a bound to one sulfur atom from the polymer chain 32b, thereby forming some polymer chains 32a-32b within the composition 320.

Referring back to both FIGS. 1 and 2, in some cases, the article 200 of FIG. 2 can be prepared by contacting a second object 24 to a surface of the composition 12 of the article 100, optionally using pressure and/or elevated heat, until sufficient rearrangement of disulfide bridges occurs that the second object 24 is adhered to the composition 12 to form the article 200.

### Methods

In a third aspect, a method of making an article is provided. The method comprises:
applying a polymerizable mixture to at least a portion of an exterior surface of an object, the polymerizable mixture comprising:
a multifunctional epoxy component;
a polysulfide component comprising at least one disulfide bridge; and
a base having a sufficiently high basicity to deprotonate an —SH group of the polysulfide component,
wherein the reaction product is in a form of a polymeric matrix; and polymerizing the mixture to form an at least partially cured composition.

In a fourth aspect, a method of making an article is provided. The method comprises:
obtaining an at least partially cured composition that is a reaction product of a polymerizable mixture, the polymerizable mixture comprising:
a multifunctional epoxy component;
a polysulfide component comprising at least one disulfide bridge; and
a base having a sufficiently high basicity to deprotonate an —SH group of the polysulfide component,
wherein the reaction product is in a form of a polymeric matrix;
directly contacting the at least partially cured composition with at least a portion of an exterior surface of an object; and
maintaining the direct contact between the at least partially cured composition and the exterior surface of the object for a time sufficient for the rearrangement of disulfide bridges to adhere the at least partially cured composition to the exterior surface of the object.

In a fifth aspect, a method of adhering two objects together is provided. The method comprises:
obtaining a first article according to the second aspect, wherein the object is a first object and the composition is a first composition;
obtaining a second article according to the second aspect, wherein the object is a second object and the composition is a second composition;
directly contacting the first composition with the second composition; and
maintaining the direct contact between the first composition and the second composition for a time sufficient for the formation of disulfide bridges between the first composition and the second composition, thereby adhering the first object and the second object together.

The polymerizable mixture, at least partially cured composition, object, and article, are each as described in detail above with respect to the first and second aspects, including any of the various embodiments described therein.

The method of application of the polymerizable mixture in the method of the third aspect is not particularly limited. For instance, the polymerizable mixture can be applied by any of spraying, bar coating, brushing, dipping, or curtain coating. Applying mixtures using such methods is well known to those of skill in the coating arts.

While some use of elevated temperature may be employed to assist in the polymerization of the polymerizable mixture, it is not strictly necessary, plus can be applied at relatively low temperatures. For instance, in some embodiments, the polymerizable mixture is polymerized at a temperature of no greater than 70 degrees Celsius (° C.), 65° C., 60° C., 55° C., 50° C., 45° C., 40° C., 35° C., or no greater than 30° C., such as at room temperature (i.e., 20° C. to 25° C.).

In some cases, direct contact between a composition or an at least partially cured composition with one of a surface of an object, a second composition, or a second at least partially cured composition, may be enhanced through the use of a fastener to hold the two materials in place as they are physically touching each other while the disulfide bridges open and close during the process of adhering the two materials together. As such, in certain embodiments, the two materials are contacted with zero gap contact. Suitable fasteners are not particularly limited; in some cases, the fastener may be a binder clip. It is explicitly contemplated that the two materials may be mixed and matched, for instance as the below pairs of materials in direct contact with each other:
a composition and an exterior surface of an object;
a first composition and a second composition;
an at least partially cured composition and an exterior surface of an object;
a first at least partially cured composition and a second at least partially cured composition; and
a composition and an at least partially cured composition.

Similar to the polymerization temperature discussed above, in some embodiments, two materials may be maintained in direct contact with each other at a temperature of no greater than 70° C., 65° C., 60° C., 55° C., 50° C., 45° C., 40° C., 35° C., or no greater than 30° C., such as at room temperature (i.e., 20° C. to 25° C.). Stated another way, the two materials (e.g., a first composition and a second composition) are optionally maintained in direct contact with each other at a temperature of between 20° C. and 70° C.

In some cases, the methods include substantially fully curing the at least partially cured composition. In the context of the present disclosure, the expression “substantially fully curing” is meant to express that more than 90 wt. %, more than 95 wt. %, more than 98 wt. %, or even more than 99 wt. % of the overall amount of the polymerizable material is polymerized/cured as the result of the polymerization/curing step(s).

In the method of the fifth aspect, two articles, each as depicted in FIG. 1, are brought into contact together, with the composition 12 of each article 100 in direct contact. Following the formation of disulfide bridges between the first composition and the second composition, the final article is as depicted in FIG. 2, in which the two compositions 12 have bonded to form one composition 22.

The polymerizable mixture or the partially or fully cured composition of the disclosure may optionally be shaped in the form of a three-dimensional item. Suitable three-dimensional item shapes for use herein will broadly vary depending on the targeted bonding application and the specific configuration of the assembly to bond, in particular the bonding area. Exemplary three-dimensional item shapes for use herein will be easily identified by those skilled in the art in the light of the present disclosure. According to one exemplary aspect of the present disclosure, the three-dimensional item has a shape selected from the group consisting of circular, semi-circular, ellipsoidal, square, rectangular, triangular, trapezoidal, polygonal shape, or any combinations thereof. In the context of the present disclosure, the shape of the three-dimensional item is herein meant to refer to the shape of the section of the three-dimensional item according to a direction substantially perpendicular to the greatest dimension of the three-dimensional item.

In a sixth aspect, a method of aiding debonding of a first object from a second object is provided. The method comprises:
obtaining an article comprising a first object having an exterior surface; a composition attached to at least a portion of the exterior surface of the first object; and a second object adhered to the composition opposite the first object; wherein the composition comprises a foaming agent and a reaction product of a polymerizable mixture comprising:
a multifunctional epoxy component;
a polysulfide component comprising at least one disulfide bridge; and
a base having a sufficiently high basicity to deprotonate an —SH group of the polysulfide component,
wherein the reaction product is in a form of a polymeric matrix; and
activating the foaming agent to form a foam composition, thereby decreasing a cohesion within the composition.

The polymerizable mixture, composition, first object, second object, and article, are each as described in detail above with respect to the first and second aspects, including any of the various embodiments described therein.

Many bonding solutions (e.g., adhesives) have one thing in common: once the bond line is closed and all products have reached their final strength, it is very difficult to take those bonded parts apart again. For instance, bond lines are usually thin and hard to reach with the right tools, and/or components might be fragile and cannot be manipulated with higher forces while ensuring that the parts can be re-used or recycled accordingly. Here, a method of aiding debonding of two objects has a practical advantage in later separating the objects when needed. Use of a latent foaming agent that is activated when desired aids in reducing cohesion within the composition, helping in the process of separating the two objects.

Suitable foaming agents can include an expandable microsphere as described above with respect to the first aspect. The foaming agent can also include an exothermic chemical blowing agent, an endothermic chemical blowing agent, a physical blowing agent, or mixtures thereof. Examples of suitable exothermic chemical blowing agents include an azo compound, a diazo compound, a sulfonyl hydrazide, a sulfonyl semicarbazide, a tetrazole, a nitroso compound, an acyl sulfonyl hydrazide, a hydrazine, a thiatriazole, an azides, a sulfonyl azide, an oxalate, a thiatrizene dioxide, isotoic anhydride, ammonium nitrite, or mixtures thereof. Examples of suitable endothermic chemical blowing agents include an inorganic carbonate, a bicarbonate, a nitrate, a borohydride, citric acid, polycarbonic acid, or mixtures thereof. The physical blowing agent can include a compressed gas, a liquid, a solid, or mixtures thereof. Specific materials that can be suitable physical blowing agents include carbon dioxide, nitrogen, argon, water, butane, 2,2-dimethylpropane, pentane, hexane, heptane, 1-pentene, 1-hexene, 1-heptene, benzene, toluene, a fluorinated hydrocarbon, methanol, ethanol, isopropanol, ethyl ether, isopropyl ketone, or mixtures thereof.

In some cases, the foaming agent is activated by exposure to a temperature of 100° C. or greater, 105° C., 110° C., 115° C., 120° C., 125° C., 130° C., 135° C., or 140° C. or greater; and 150° C. or less. Stated another way, in certain embodiments, the foaming agent is activated by exposure to a temperature of 100° C. to 150° C. The use of a foaming agent that is activated at such elevated temperatures allows the foaming agent to remain unactivated under typical handling conditions, even if a temperature of up to 70° C. is applied during formation of an article, as discussed above.

### Select Embodiments of the Present Disclosure

In a first embodiment is provided a composition. The composition comprises a reaction product of a polymerizable mixture comprising a multifunctional epoxy component; a polysulfide component comprising at least one disulfide bridge; and a base having a sufficiently high basicity to deprotonate an —SH group of the polysulfide component. The reaction product is in a form of a polymeric matrix.

In a second embodiment is provided a composition according to the first embodiment, further comprising a filler distributed in the polymeric matrix in an amount of 30 to 70 volume percent (vol. %), based on the total volume of the composition.

In a third embodiment is provided a composition according to the first embodiment, further comprising a filler distributed in the polymeric matrix in an amount of 30 to 70 weight percent (wt. %), based on the total weight of the composition.

In a fourth embodiment is provided a composition according to the second embodiment or the third embodiment, wherein the filler is selected from the group consisting of lightweight particles, foaming agents, expandable minerals, expanded microspheres, flame retardants, thermally conductive particles, thermally insulating particles, electrically conductive particles, electrically insulative particles, and combinations thereof.

In a fifth embodiment is provided a composition according to any of the second through fourth embodiments, wherein the composition or the polymerizable mixture further comprises at least one additive selected from the group consisting of a colorant, a plasticizer, a catalyst, a diluent, and combinations thereof.

In a sixth embodiment is provided a composition according to any of the second through fifth embodiments, having a form of a foamed polymeric matrix.

In a seventh embodiment is provided a composition according to any of the second through sixth embodiments, wherein the multifunctional epoxy component comprises at least one of a difunctional epoxy component, a trifunctional epoxy component, or a tetrafunctional epoxy component.

In an eighth embodiment is provided a composition according to any of the second through seventh embodiments, wherein the multifunctional epoxy component comprises at least one of an aromatic epoxy component, a fully or partially hydrogenated epoxy component, or combinations thereof.

In a ninth embodiment is provided a composition according to any of the second through eighth embodiments, wherein the multifunctional epoxy component comprises at least one of a novolac-based epoxy component, a bisphenol A-based epoxy component, or a bisphenol F-based epoxy component.

In a tenth embodiment is provided a composition according to any of the second through ninth embodiments, wherein the polysulfide component comprises at least five disulfide bridges.

In an eleventh embodiment is provided a composition according to any of the second through tenth embodiments, wherein the polysulfide component comprises thiol end groups.

In a twelfth embodiment is provided a composition according to any of the second through eleventh embodiments, wherein the base comprises at least one of a primary amine, a secondary amine, a tertiary amine, a cyclic amine, an aromatic amine, a monofunctional amine, a multifunctional amine, an epoxy-amine adduct, an amide, or any combination thereof.

In a thirteenth embodiment is provided a composition according to any of the second through tenth embodiments, wherein the base comprises at least one of a primary amine, a secondary amine, a tertiary amine, or a multifunctional amine.

In a fourteenth embodiment is provided an article. The article comprises an object having an exterior surface and a composition attached to at least a portion of the exterior surface of the object. The composition comprises a reaction product of a polymerizable mixture comprising a multifunctional epoxy component; a polysulfide component comprising at least one disulfide bridge; and a base having a sufficiently high basicity to deprotonate an —SH group of the polysulfide component. The reaction product is in a form of a polymeric matrix.

In a fifteenth embodiment is provided an article according to the fourteenth embodiment, wherein the object comprises a substrate having a major surface to which the composition is attached.

In a sixteenth embodiment is provided an article according to the fourteenth embodiment, wherein the object comprises a nonplanar exterior surface.

In a seventeenth embodiment is provided an article according to any of the fourteenth through sixteenth embodiments, wherein the object is a first object and the article further comprises a second object adhered to the composition opposite the first object.

In an eighteenth embodiment is provided an article according to the seventeenth embodiment, wherein the composition is laminated between the first object and the second object.

In a nineteenth embodiment is provided an article according to any of the fourteenth through eighteenth embodiments, wherein the composition is according to any of the first through thirteenth embodiments.

In a twentieth embodiment is provided a method of making an article. The method comprises applying a polymerizable mixture to at least a portion of an exterior surface of an object and polymerizing the mixture to form an at least partially cured composition. The polymerizable mixture comprises a multifunctional epoxy component; a polysulfide component comprising at least one disulfide bridge; and a base having a sufficiently high basicity to deprotonate an —SH group of the polysulfide component. The reaction product is in a form of a polymeric matrix.

In a twenty-first embodiment is provided a method of making an article according to the twentieth embodiment, wherein the polymerizable mixture is applied by spraying, bar coating, brushing, dipping, or curtain coating.

In a twenty-second embodiment is provided a method of making an article according to the twentieth embodiment or the twenty-first embodiment, wherein the polymerizable mixture is polymerized at a temperature of no greater than 70 degrees Celsius.

In a twenty-third embodiment is provided a method of making an article according to any of the twentieth through twenty-second embodiments, wherein the at least partially cured composition is a composition according to any of the first through thirteenth embodiments.

In a twenty-fourth embodiment is provided another method of making an article. The method comprises obtaining an at least partially cured composition that is a reaction product of a polymerizable mixture. The polymerizable mixture comprises a multifunctional epoxy component; a polysulfide component comprising at least one disulfide bridge; and a base having a sufficiently high basicity to deprotonate an —SH group of the polysulfide component. The reaction product is in a form of a polymeric matrix. The method further comprises directly contacting the at least partially cured composition with at least a portion of an exterior surface of an object and maintaining the direct contact between the at least partially cured composition and the exterior surface of the object for a time sufficient for the rearrangement of disulfide bridges to adhere the at least partially cured composition to the exterior surface of the object.

In a twenty-fifth embodiment is provided a method of adhering two objects together. The method comprises obtaining a first article according to the second aspect, in which the object is a first object and the composition is a first composition; and obtaining a second article according to the second aspect, in which the object is a second object and the composition is a second composition. The method further comprises directly contacting the first composition with the second composition; and maintaining the direct contact between the first composition and the second composition for a time sufficient for the formation of disulfide bridges between the first composition and the second composition, thereby adhering the first object and the second object together.

In a twenty-sixth embodiment is provided a method of adhering two objects together according to the twenty-fifth embodiment, wherein the first composition and the second composition are contacted with zero gap contact.

In a twenty-seventh embodiment is provided a method of adhering two objects together according to the twenty-fifth embodiment or the twenty-sixth embodiment, wherein the first composition and the second composition are maintained in direct contact at a temperature of between 20 degrees Celsius and 70 degrees Celsius.

In a twenty-eighth embodiment is provided a method of adhering two objects together according to any of the twenty-fourth through twenty-seventh embodiments, wherein the first composition and the second composition are independently according to any of the first through thirteenth embodiments.

In a twenty-ninth embodiment is provided a method of aiding debonding of a first object from a second object. The method comprises obtaining an article comprising a first object having an exterior surface; a composition attached to at least a portion of the exterior surface of the first object; and a second object adhered to the composition opposite the first object. The composition comprises a foaming agent and a reaction product of a polymerizable mixture comprising a multifunctional epoxy component; a polysulfide component comprising at least one disulfide bridge; and a base having a sufficiently high basicity to deprotonate an —SH group of the polysulfide component. The reaction product is in a form of a polymeric matrix. The method also comprises activating the foaming agent to form a foam composition, thereby decreasing a cohesion within the composition.

In a thirtieth embodiment is provided a method of aiding debonding of a first object from a second object according to the twenty-ninth embodiment, wherein the foaming agent is activated by exposure to a temperature of 100 to 150 degrees Celsius.

In a thirty-first embodiment is provided a method of aiding debonding of a first object from a second object according to the twenty-ninth embodiment or the thirtieth embodiment, wherein the composition is according to any of the first through thirteenth embodiments.

In a thirty-second embodiment is provided a method of aiding debonding of a first object from a second object according to any of the twenty-ninth through thirty-first embodiments, wherein the foaming agent comprises expandable microspheres.

Objects and advantages of this disclosure are further illustrated by the following non-limiting examples, but the particular materials and amounts thereof recited in these examples, as well as other conditions and details, should not be construed to unduly limit this disclosure.

### Examples

The present disclosure is further illustrated by the following examples. These examples are merely for illustrative purposes only and are not meant to be limiting on the scope of the appended claims. Unless otherwise noted, all parts, percentages, ratios, etc. in the Examples and the rest of the specification are by weight.

### Test Methods:

### Preparation of the Formulations for Testing:

The polymerizable mixtures were prepared and mixed together using a planetary high-speed mixer (DAC 150 FVZ Speedmixer, available from Hauschild Engineering, Germany) stirring at 3500 rpm. The preparation of the various components is described hereinafter. After a homogeneous mixture was achieved, the formulations were either extruded between two liners producing a film having specific thickness by using a knife coater or were applied as a paste onto surfaces.

### Application of Self-Joining Bonding Materials:

Generally, two different approaches can be taken to apply self-joining bonding compositions.

### 1.) Pre-Application

The freshly mixed polymerizable material can be applied via various methods including bar-coating, spraying, brushing, dipping or curtain coating. Subsequently the self-joining bonding material will be dried at a convenient temperature and the non-tacky coated compositions can then then be stored without special precautions. For the self-joining step, the coated articles will be placed in direct contact with each other at a given pressure (e.g., by SBS® Binder Clips) and temperature to initiate the fusion between the two coated layers in contact.

### 2.) Bonding Film

The freshly mixed polymerizable material is transformed into a film of given thickness using a standard laboratory knife coater. The film is allowed to cure at room temperature. The resulting non-tacky layer can subsequently be cut into shape (die cut) and placed between the two surfaces to be bonded. When assembled with low to medium pressure (e.g., by SBS® Binder Clips), the self-joining bonding composition will fuse with the two surfaces to yield a fully bonded joint in 1 hour at 65° C.

### Mechanical Testing of Specimens:

### 1) Overlap Shear Strength (OLS) According to DIN EN 1465.

The surface of the OLS metal sheets (automotive grade aluminum 6016, 1.2 mm thickness) were cleaned with MEK. The metal sheets were left at ambient room temperature (23° C.+/−2° C., 50% relative humidity+/−5%) for 15 minutes prior to applying the self-joining bonding composition and the OLS strength was measured as described below. Overlap shear strength was determined according to DIN EN 1465 using a Zwick Z050 tensile tester (commercially available from Zwick GmbH & Co. KG, Ulm, Germany) operating at a cross head speed of 10 millimeters per minute (mm/min). For the preparation of an OLS test assembly, a film of the cured composition was placed onto one surface of a prepared metal sheet before the second metal sheet is placed on top of the film to close the bond line with an overlap length of 13 mm. The overlap joints were then clamped together using two 32 mm wide SBS® Binder Clips and the test assemblies were further stored at room temperature for 30 minutes after closing the bond line, and then placed into an air circulating oven available from Heraeus (duration and temperatures for the self-joining step to be taken from example sections). The next day, the samples were tested directly. Five samples were measured for each of the examples and results were averaged and reported in MPa.

### 2) Butt Joint Tension Test (T-Block) Based on TM-1095/DIN EN 15870

The surface of the bonding area of the T-Blocks (AlMg₃) was cleaned with MEK and 3M performance panel wipes. The full area (25 mm×25 mm) was covered with a film of cured self-joining bonding composition and the second T-Block was placed on the opposite side. Both T-Blocks were subsequently fixed with two 32 mm wide SBSR Binder Clips before placing the samples in the oven for the self-joining step.

### 3) Tensile Testing of Dumbbell Specimen According to DIN EN ISO 527-3 (Type 5 Geometry)

Between two layers of 50 micrometer thick siliconized PET liner, a 1 mm thick film of polymerizable material was prepared using a standard laboratory knife coater. The film was allowed to cure at 23° C. for at least 24 hours. Type 5 geometries were subsequently stamped out of the film using a semi-automated press to yield at least 5 specimens for further measurements. The specimens were tested using a Zwick Z050 tensile tester equipped with a mechanical displacement transducer (commercially available from Zwick GmbH & Co. KG, Ulm, Germany) operating at a cross head speed of 10 mm/min. The displacement and forces were then reported as stress and strain values for each specimen.

### Raw Materials:

In the examples, the following raw materials are used:
Epikote 828 is an epoxy resin, commercially available from Hexion Specialty Chemicals GmbH, Iserlohn, Germany.
Eponex 1510 is a hydrogenated bisphenol epoxy resin, commercially available from Hexion Specialty Chemicals GmbH, Iserlohn, Germany.
Thioplast G44 is a multifunctional polysulfide polymer building block, commercially available from Nouryon, Amsterdam, Netherlands.
Baxxodur EC 130 is 4,7,10-trioxatridecane-1,13-diamine, a curing agent commercially available from BASF, Ludwigshafen, Germany.
Cardolite NX2026 is a cardanol based catalyst and diluent, commercially available from Cardolite Specialty Chemicals Europe NV, Mariakerke (Gent), Belgium.
Aerosil R202 is fumed silica, a thixotrope, commercially available from Evonik, Essen, Germany.
Ancamine K45 is a functional phenol, initiator and catalyst, commercially available from Evonik, Essen, Germany.
Ancamine 3456 is a functional a formulated aliphatic polyamine adduct, commercially available from Evonik, Essen, Germany.
BF083 is aluminum hydroxide, a flame-retardant filler, commercially available from Nippon Light Metal Ltd., Tokyo, Japan.
BAK-1/10/40 is spherical alumina, a thermally conductive filler with different sizes of alumina particles, commercially available from Yaan Bestry Performance Materials Corp., Shanghai, China.
MoldX A110 is aluminum hydroxide, a flame-retardant filler, commercially available from J.M. Huber Corp., Atlanta, United States.
Dualite E030 are expanded microspheres, a lightweight filler, commercially available from Chase Corp., Westwood, United States.
Matsumoto F48D* are expandable microspheres, a foaming agent, commercially available from Matsumoto Yushi-Seiyaku Co., Ltd, Osaka, Japan.
Phlogopite Mica PW 80 is a phyllosilicate for electrically insulation and high-temperature performance, commercially available from Lingshou County Huayuan Mica Co., Ltd., Shijiazhuang, China.
Kenflex A 95/5 is a polymeric plasticizer, a dimethylnaphthalene oligomer, commercially available from Farrl GmbH, Frankfurt a. M., Germany.
Kronos 2059 is titanium dioxide, commercially available from Kronos International, Leverkusen, Germany.
Volite 200 is a blown volcanic rock used as a lightweight mineral additive, commercially available from Knauf Aquapanel GmbH, Dortmund, Germany.
ZHS is zinc hydroxy stannate, a flame-retardant synergist, commercially available from William Blythe Ltd., Accrington Lancashire, United Kingdom.
Expancel 920 DE 80 d30, are expanded microspheres, a lightweight filler, commercially available from Nouryon, Amsterdam, Netherlands.
Raven DP1255 is a carbon black pigment, commercially available from Birla Carbon, Hannover, Germany.

### EXAMPLES

### Preparation of Examples

The examples were prepared by combining the ingredients from the list of materials shown in Table 1. As a general guideline for this, Example 1 can be taken. Thioplast G44, Epikote 828 and Cardolite NX-2026 were first placed in a small beaker and mixed together using a planetary high-speed mixer (DAC 150 FVZ Speedmixer, available from Hauschild Engineering, Germany) stirring at 3500 rpm for 1 minute. Any fillers (like BAK-10) were added and mixed into the resins under vacuum at 1500 rpm for 2 minutes using a high-speed vacuum mixer (ARV-130 Thinky Mixer, available from Thinky Corporation, USA). Subsequently, the curing reaction of the material was initiated by addition of Ancamine K54 to this mixture, which was blended into the mixture at 3500 rpm for 1 minute. The material was either directly applied to a surface or extruded between two liners producing a film having a thickness of 0.3 mm by using a knife coater.

TABLE 1
Formulation details for Examples 1-3.

| | Example 1 | Example 2 | |
|---|---|---|---|
| | thermal | flame | Example 3 |
| comment/density of | conductivity/ | retardancy/ | low density/ |
| material | d = 2.58g/cm³ | d = 1.58 g/cm³ | d = 0.62 g/cm³ |
| Raw material | wt. % | wt. % | wt. % |
| Thioplast G44 | 14.58 | 19.72 | 60.98 |
| Epikote 828 | 7.29 | 9.86 | 30.49 |
| Ancamine K54 | 0.73 | 0.99 | 3.05 |
| Cardolite NX-2026 | 0.73 | 0.99 | 3.05 |
| BAK-10 | 76.67 | — | — |
| BF083 - ATH | — | 63.53 | — |
| ZHS Zinc hydroxy | | 4.93 | — |
| stannate | | | |
| Dualite E030 | — | — | 2.44 |

TABLE 2
Overlap Shear Strength (OLS) according to DIN EN 1465 for
Examples 1-3.

| Specimen | Bonding conditions | Result [MPa] |
|---|---|---|
| Example 2 | 1 h @ 65° C. | 5.16 |

TABLE 3
Butt Joint Tension Test (T-Block) based on TM-1095 / DIN EN
15870.

| Specimen | Self-joining conditions | Result [N] |
|---|---|---|
| Example 1 | 2 h @ 100° C. | 487 |
| Example 2 | 1 h @ 65° C. | 1020 |
| Example 3 | 1 h @ 100° C. | 406 |
| Example 3 | 2 h @ 45° C. | 278 |

TABLE 4
Tensile testing of dumbbell specimen according to DIN EN ISO
527-3 (Type 5 geometry).

| Specimen | Example 1 | Example 2 | Example 3 |
|---|---|---|---|
| max. stress [MPa] | 1.16 | 3.40 | 0.66 |
| max. strain [%] | 117.91 | 66.21 | 131.81 |
| elastic strain [%] | 3.88 | 11.66 | 10.10 |
| plastic strain [%] | 114.03 | 54.55 | 121.71 |
| yield stress [MPa] | 0.76 | 1.42 | 0.25 |
| yield strain [%] | 5.36 | 5.74 | 5.53 |
| strain energy [J/m²] | 106.87 | 190.50 | 73.84 |
| E-modulus [MPa] | 15 | 26 | 5 |

### Determination of Resistance to Humidity According to DIN EN ISO 6270-2 CH for Example 2

To determine the resistance to humidity, 5 OLS samples of Example 2 were prepared as previously described, cured for 1 hour at 60° C. in an oven and subsequently were subjected to 7 days of aging according to DIN EN ISO 6270-2 CH under 40° C. and 100% relative humidity (r.H.). After conditioning of 24 hours at 23° C. and 50% r.H., the samples were tested as described before for OLS samples according to DIN EN 1465. The values after aging were then compared to the initial values. The aged samples (OLS 3.11 MPa) proved to have >60% strength retention compared to unaged samples (OLS 5.16 MPa) while the predominant failure mode remained >90% cohesive.

### Investigation of Self-Joining Bonding Materials in Repair Situations.

One of the more interesting and especially useful property of self-joining bonding compositions is the capability to “re-bond” after mechanical destruction of the bond line. As most of the samples that were investigated proved to have cohesive failure modes on non-treated 60616 aluminum, a simple experiment was set up to check if the self-joining motif would be available after breaking the initial bond line. For this, OLS samples that were tested several days prior as described before were just put back together in the best possible way, trying to mate the broken surfaces to resemble a homogeneous layer. Then, two 32 mm wide SBS® Binder clips were placed on each specimen just as when bonding the layer in the first place. Samples were then re-conditioned for 1 hour @ 65° C. in a laboratory oven and tested after an additional hour at 23° C. and 50% r.H.

Surprisingly, the re-bonded samples came out to have 70-100% strength retention after the short time at elevated temperatures. The large deviation in the results could clearly be attributed to the effectiveness in which the initial layer of material could be re-constructed by just simply bringing the sample surfaces into direct contact again without any further surface conditioning.

### Electrical Testing of Self-Joining Bonding Materials

To provide confidence that the chemistry used to prepare self-joining bonding compositions is suitable for use in applications e.g., EV battery and mobile handheld devices, electrical testing according to DIN EN 60112:2010-05 (VDE 0303-11:2010-05) was conducted with Example 1. In this test, the determination of the proof and the comparative tracking indices of solid insulating materials is evaluated. To be compliant with current specification within an EV battery box, compositions were tested according to paragraph 3.5 (CTI), where 50 controlled drops of 0.1% ammonium chloride solution (NH₄Cl) of a specific resistivity of 3.95+−0.05 Ωm were placed on 5 different samples of material without triggering the surge relay.

TABLE 5
Results of electrical testing of Eample 1 according to DIN EN
60112: 2010-05 (VDE 0303-11: 2010-05).

| Thickness | Layers | | |
|---|---|---|---|
| [mm] | # | Drops / Voltage | Result |
| 1.08 | 3 | 50 / 400 V | 5 of 5 passed |
| 1.08 | 3 | 100 / 375 V | 5 of 5 passed |
| 1.08 | 3 | 100 / 575 V | 1 of 1 passed |
| 1.08 | 3 | 50 / 600 V | 1 of 1 passed |

TABLE 6
Further formulations for Examples 4-6.

| | Example 4 | Example 5 | |
|---|---|---|---|
| | Elongation and | Thermal | |
| comment/ | electrical | conductivity/ | Example 6 |
| property of | breakdown | no self- | low density/ |
| material | strength. | bonding | d = 0.62 g/cm³ |
| Raw material | wt. % | wt. % | wt. % |
| Thioplast G44 | 49.85 | 4.94 | 22.85 |
| Epikote 828 | 30.21 | 2.96 | 11.31 |
| Ancamine K54 | 1.81 | — | 1.13 |
| Ancamine 3456 | — | 2.47 | — |
| Cardolite NX-2026 | 3.02 | — | 1.13 |
| Kenflex A95/5 | 15.11 | — | — |
| BAK-40 | — | 53.18 | — |
| BAK-10 | — | 17.73 | — |
| BAK-1 | — | 17.73 | — |
| BF083 - ATH | — | 63.53 | — |
| ZHS Zinc hydroxy | — | 0.99 | — |
| stannate | | | |
| Matsumoto F-48D* | — | — | 5.47 |
| BF083 - ATH | — | — | 54.70 |
| Kronos 2059 | — | — | 2.19 |
| Aerosil R202 | — | — | 1.22 |

### Testing for Thermal Conductivity According to ASTM E1461

The thermal conductivity of Example 5 was measured according to ASTM E1461 at 23° C. with Laser Flash Analysis (LFA) using Light Flash Apparatus LFA 467 HyperFlash®, commercially available from Netzsch GmbH, Germany, on samples having a thickness of 2 mm. The measured value for thermal conductivity was about 3 watts per meter-Kelvin (W/mK).

TABLE 7
Further formulations for Examples 7 and 8 optimized for low density.

| | Example 7 | Example 8 |
|---|---|---|
| comment/property of | low density/ | low density/ |
| material | d = 0.59 g/cm₃ | d = 0.61 g/cm₃ |
| Raw material | wt. % | wt. % |
| Epikote 828 | 40.32 | 53.76 |
| Thioplast G44 | 40.32 | 26.88 |
| Baxxodur EC 130 | 10.75 | 10.75 |
| Ancamine K54 | 1.61 | 1.61 |
| Cardolite NX-2026 | 1.61 | 1.61 |
| Dualite E030 | 5.38 | 5.38 |

### Expandable/Foaming Formulation Examples 9-11

According to the previously described procedure for the preparation of examples, three more formulations were prepared to be used as expandable materials for applications that need a weak bonding foam or an adhesive that can be debonded by expanding the composition by heat and thus lowering the cohesion. The details are described in

TABLE 8
Further formulations for Examples 9 -11.

| | Example 9 | Example 10 | Example 11 |
|---|---|---|---|
| Raw material | wt. % | wt. % | wt. % |
| Thioplast G44 | 30.35 | 29.86 | 29.04 |
| BF083 - ATH | 32.81 | 32.28 | 31.39 |
| Cardolite NX-2026 | 1.53 | 1.50 | 1.46 |
| Epikote 828 | 15.26 | 15.01 | 14.60 |
| Ancamine K54 | 1.53 | 1.50 | 1.46 |
| MoldX A110 | 16.40 | 16.14 | 15.70 |
| Expancel 920 DE 80 d30 | 1.23 | 1.21 | — |
| Raven DP1255 | 0.08 | 0.08 | 0.08 |
| Matsumoto F-48D | 0.82 | 2.42 | 1.46 |

Subsequently, 1 mm thick films of the polymerizable mixture were prepared using a laboratory knife coater and the films were left to cure at room temperature for 24 hours. After this, the liners were removed, and round buttons were prepared from the films using a hollow punch of 20 mm diameter. The buttons were measures in thickness and exposed to a heat bump of 120° C. for 3 minutes. After cooling down to room temperature, the buttons were measured again to derive the volumetric degree of expansion (the results are compiled in Table 9).

TABLE 9
Volume expansion of buttons samples of Example 9-11.
The volume of cylindrical buttons was
calculated using the following formula:
V_{(cylinder)} = r2 * Pi * h with (r): radius and (h): height of the button.

| | initial | | | after expansion | | | |
|---|---|---|---|---|---|---|---|
| | d | h | V (ini) | d | h | V (exp) | exp. |
| | [mm] | [mm] | [mm³] | [mm] | [mm] | [mm³] | factor |
| Example 9 | 20 | 1.02 | 320.44 | 22.05 | 1.25 | 477.33 | 1.5 |
| Example 10 | 20 | 1.08 | 339.29 | 25.51 | 1.32 | 674.66 | 2.0 |
| Example 11 | 20 | 1.14 | 358.14 | 31.41 | 1.85 | 1433.50 | 4.0 |

To evaluate the impact of the various degrees of expansion on the mechanical properties and as a result impact the debonding capability of a given composition, overlap shear (OLS) and T-block samples were prepared according to the previously described methods and measured in unexpanded (initial) and expanded condition. The following tables gives an overview on the mechanical performance in shear and tensile mode for OLS and T-block respectively.

TABLE 10
Volume expansion of OLS samples for Examples 9-11
(for overlap shear samples with 13 mm × 25 mm bond area).

| | Example 9 | OLS | Example 10 | OLS | Example 11 | OLS |
|---|---|---|---|---|---|---|
| | Initial- | Expanded- | Initial- | Expanded- | Initial- | Expanded- |
| | Thickness | Thickness | Thickness | Thickness | Thickness | Thickness |
| Specimen | [mm] | [mm] | [mm] | [mm] | [mm] | [mm] |
| 1 | 0.28 | 0.28 | 0.35 | 0.92 | 0.39 | 1.32 |
| 2 | 0.08 | 0.40 | 0.27 | 0.76 | 0.33 | 1.35 |
| 3 | 0.17 | 0.26 | 0.57 | 0.38 | 0.30 | 1.22 |
| 4 | 0.23 | 0.60 | 0.32 | 1.05 | 0.32 | 1.21 |
| 5 | 0.25 | 0.40 | 0.34 | 0.92 | 0.42 | 1.24 |
| Average | 0.20 | 0.39 | 0.37 | 0.81 | 0.35 | 1.27 |
| Standard | 0.07 | 0.12 | 0.10 | 0.23 | 0.05 | 0.06 |
| Deviation | | | | | | |
| Increase | | 92% | | 118% | | 260% |

TABLE 11
Shear force reduction of OLS samples for Examples 9-11
(for overlap shear samples with 13 mm × 25 mm bond area).

| | Example 9 | OLS | Example 10 | OLS | Example 11 | OLS |
|---|---|---|---|---|---|---|
| | Initial-OLS | Expanded- | Initial-OLS | Expanded- | Initial-OLS | Expanded- |
| Specimen | [MPa] | OLS [MPa] | [MPa] | OLS [MPa] | [MPa] | OLS [MPa] |
| 1 | 1.87 | 0.457 | 2.00 | 0.442 | 3.91 | 0.203 |
| 2 | 2.90 | 0.463 | 2.08 | 0.189 | 3.60 | —* |
| 3 | 2.27 | 0.500 | 2.23 | 0.236 | 3.60 | —* |
| 4 | 2.08 | 0.461 | 2.08 | 0.281 | 4.10 | —* |
| 5 | 2.23 | 0.442 | 2.12 | 0.061 | 4.15 | —* |
| Average | 2.27 | 0.465 | 2.10 | 0.242 | 3.87 | 0.203 |
| Standard | 0.34 | 0.02 | 0.07 | 0.12 | 0.24 | 0.00 |
| Deviation | | | | | | |
| Reduction | | 80% | | 89% | | 95% |
| of OLS | | | | | | |
| strength | | | | | | |

—*OLS strength was too low to be measured by testing machine.

TABLE 12
Volume expansion of T-Block samples for Examples 9-11
(for T-block samples with 25 mm × 25 mm bond area).

| | Example 9 | OLS | Example 10 | OLS | Example 11 | OLS |
|---|---|---|---|---|---|---|
| | Initial- | Expanded- | Initial- | Expanded- | Initial- | Expanded- |
| | Thickness | Thickness | Thickness | Thickness | Thickness | Thickness |
| Specimen | [mm] | [mm] | [mm] | [mm] | [mm] | [mm] |
| 1 | 0.55 | 0.49 | 0.39 | 0.34 | 0.35 | 1.51 |
| 2 | 0.39 | 0.31 | 0.48 | 0.71 | 0.41 | 1.57 |
| 3 | 0.54 | 0.62 | 0.38 | 0.43 | 0.32 | 2.27 |
| 4 | 0.53 | 0.61 | 0.47 | 0.52 | 0.37 | 1.61 |
| 5 | 0.42 | 0.60 | 0.47 | 0.45 | 0.14 | 1.81 |
| Average | 0.49 | 0.53 | 0.44 | 0.49 | 0.32 | 1.75 |
| Standard | 0.07 | 0.12 | 0.04 | 0.12 | 0.09 | 0.28 |
| Deviation | | | | | | |
| Increase | | 8% | | 12% | | 452% |

TABLE 13
Tensile force reduction of T-Block samples for Examples 9-11
(for T-block samples with 25 mm × 25 mm bond area).

| | Example 9 | OLS | Example 10 | OLS | Example 11 | OLS |
|---|---|---|---|---|---|---|
| | Initial- | Expanded- | Initial- | Expanded- | Initial- | Expanded- |
| | Tensile force | Tensile force | Tensile force | Tensile force | Tensile force | Tensile force |
| Specimen | [N] | [N] | [N] | [N] | [N] | [N] |
| 1 | 864.36 | 190.60 | 872.80 | 104.98 | 517.55 | 100.79 |
| 2 | 991.30 | 191.59 | 869.11 | 117.57 | 516.83 | 101.92 |
| 3 | 1013.96 | 199.56 | 908.68 | 115.76 | 517.27 | 108.36 |
| 4 | 998.56 | 193.09 | 876.68 | 125.70 | 526.50 | 102.97 |
| 5 | 984.58 | 182.89 | 900.49 | 134.39 | 522.27 | 107.08 |
| Average | 970.55 | 191.544 | 885.55 | 119.682 | 520.08 | 104.224 |
| Standard | 53.98 | 5.34 | 15.94 | 9.88 | 0.24 | 2.96 |
| Deviation | | | | | | |
| Reduction | | 80% | | 86% | | 80% |
| of tensile | | | | | | |
| force | | | | | | |

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1.-23. (canceled)

24. A method of making an article, the method comprising:
obtaining a substantially fully cured composition that is a reaction product of a polymerizable mixture, the polymerizable mixture comprising:
a multifunctional epoxy component;
a polysulfide component comprising at least one disulfide bridge; and
a base having a sufficiently high basicity to deprotonate an —SH group of the polysulfide component,
wherein the reaction product is in a form of a polymeric matrix;
directly contacting the substantially fully cured composition with at least a portion of an exterior surface of an object; and
maintaining the direct contact between the substantially fully cured composition and the exterior surface of the object for a time sufficient for the rearrangement of disulfide bridges to adhere the substantially fully cured composition to the exterior surface of the object.

25. A method of adhering two objects together, the method comprising:
obtaining a first article comprising a first object having an exterior surface and a substantially fully cured first composition attached to at least a portion of the exterior surface of the object, the first composition comprising a reaction product of a polymerizable mixture comprising: a multifunctional epoxy component; a polysulfide component comprising at least one disulfide bridge; and a base having a sufficiently high basicity to deprotonate an —SH group of the polysulfide component, wherein the reaction product is in a form of a polymeric matrix;
obtaining a second article comprising a second object having an exterior surface and a substantially fully cured second composition attached to at least a portion of the exterior surface of the object, the second composition comprising a reaction product of a polymerizable mixture comprising: a multifunctional epoxy component; a polysulfide component comprising at least one disulfide bridge; and a base having a sufficiently high basicity to deprotonate an —SH group of the polysulfide component, wherein the reaction product is in a form of a polymeric matrix;
directly contacting the substantially fully cured first composition with the substantially fully cured second composition; and
maintaining the direct contact between the substantially fully cured first composition and the substantially fully cured second composition for a time sufficient for the formation of disulfide bridges between the substantially fully cured first composition and the substantially fully cured second composition, thereby adhering the first object and the second object together.

26. The method of claim 25, wherein the substantially fully cured first composition and the substantially fully cured second composition are contacted with zero gap contact.

27. The method of claim 25, wherein the substantially fully cured first composition and the substantially fully cured second composition are maintained in direct contact at a temperature of between 20 degrees Celsius and 70 degrees Celsius.

28. (canceled)

29. A method of aiding debonding of a first object from a second object, the method comprising:
obtaining an article comprising a first object having an exterior surface; a composition attached to at least a portion of the exterior surface of the first object; and a second object adhered to the composition opposite the first object; wherein the composition comprises a foaming agent and a reaction product of a polymerizable mixture comprising:
a multifunctional epoxy component;
a polysulfide component comprising at least one disulfide bridge; and
a base having a sufficiently high basicity to deprotonate an —SH group of the polysulfide component,
wherein the reaction product is in a form of a polymeric matrix; and
activating the foaming agent to form a foam composition, thereby decreasing a cohesion within the composition.

30. The method of claim 29, wherein the foaming agent is activated by exposure to a temperature of 100 to 150 degrees Celsius.

31. (canceled)

32. The method of claim 29, wherein the foaming agent comprises expandable microspheres.

33. The method of claim 24, wherein the substantially fully cured composition further comprises a filler distributed in the polymeric matrix in an amount of 30 to 70 volume percent (vol. %), based on the total volume of the substantially fully cured composition.

34. The method of claim 24, wherein the substantially fully cured composition further comprises a filler distributed in the polymeric matrix in an amount of 30 to 70 weight percent (wt. %), based on the total weight of the substantially fully cured composition.

35. The method of claim 34, wherein the filler is selected from the group consisting of lightweight particles, foaming agents, expandable minerals, expanded microspheres, flame retardants, thermally conductive particles, thermally insulating particles, electrically conductive particles, electrically insulative particles, and combinations thereof.

36. The method of claim 24, wherein the substantially fully cured composition has a form of a foamed polymeric matrix.

37. The method of claim 24, wherein the object comprises a substrate having a major surface to which the substantially fully cured composition is attached.

38. The method of claim 24, wherein the object comprises a nonplanar exterior surface.

39. The method of claim 25, wherein the composition further comprises a filler distributed in the polymeric matrix in an amount of 30 to 70 volume percent (vol. %), based on the total volume of the composition.

40. The method of claim 25, wherein the composition further comprises a filler distributed in the polymeric matrix in an amount of 30 to 70 weight percent (wt. %), based on the total weight of the composition.

41. The method of claim 40, wherein the filler is selected from the group consisting of lightweight particles, foaming agents, expandable minerals, expanded microspheres, flame retardants, thermally conductive particles, thermally insulating particles, electrically conductive particles, electrically insulative particles, and combinations thereof.

42. The method of claim 25, wherein the first object comprises a substrate having a major surface to which the composition is attached.

43. The method of claim 25, wherein the first object comprises a nonplanar exterior surface.
